(19) United States
(12) Patent Application Publication
(10) Pub. No.: US 2011/0158552 A1
(43) Pub. Date: Jun. 30, 2011

(54) QUALITY ADJUSTING APPARATUS AND IMAGE QUALITY ADJUSTING METHOD

(75) Inventor: Takayuki ARAI, Tokyo (JP)

(73) Assignee: Kabushiki Kaisha Toshiba, Tokyo (JP)

(21) Appl. No.: 12/900,421

(22) Filed: Oct. 7, 2010

(30) Foreign Application Priority Data
Dec. 28, 2009 (JP) 2009-298516

(51) Int. Cl. G06K 9/38; G06K 9/40

(52) U.S. Cl. 382/270; 382/254

(57) ABSTRACT

An image quality adjusting apparatus includes: an output module configured to alternately output, in time division, first and second frame-rate-converted frame images that are obtained by converting first and second input frame images to increase a frame rate, respectively; a detecting module configured to detect features of each of the first and second input frame images; and an image quality adjusting module configured to perform an image quality adjustment on the first frame-rate-converted frame image based on the detected features of the first input frame image and performing an image quality adjustment on the second frame-rate-converted frame image based on the detected features of the second input frame image.

### CROSS-REFERENCE TO THE RELATED APPLICATION(S)

The present application is based upon and claims priority from prior Japanese Patent Application No. 2009-298516, filed on Dec. 28, 2009, the entire contents of which are incorporated herein by reference.

### FIELD

Embodiments described herein generally relate to an image quality adjusting apparatus and an image quality adjusting method for adjusting an image quality of video image.

### BACKGROUND

In recent years, with the increase in the screen size and the resolution of video display units of TV receivers etc., even ordinary users of TV receivers have come to visually recognize the level of display video quality. In view of this, to display high-quality video on the screen, many techniques for automatically improving the image quality utilizing information that relates to video displayed on the screen have been disclosed.

For example, a publication JP-A-2006-157775 discloses a technique of compensating the gradation values of video data for each gate line according to the time from the start of response of the liquid crystal for each gate line to turn-on of the light source for illuminating the entire screen of a liquid crystal display unit. This technique enables to prevent luminance unevenness or a ghost from occurring due to response delay of the liquid crystal.

However, in the technique described in JP-A-2006-157775, to compensate the gradation values of latest input image data (i.e., image data of a latest field), such drive voltages are applied that the rise of the response of the liquid crystal for the latest input image data based on the immediately preceding input image data that was displayed one field before. That is, in this technique, the image quality of a latest image frame (i.e., an image frame that is about to be displayed) is improved based on data of the immediately preceding image frame.

However, if it is attempted to display, on the screen, utilizing the above technique, time-division-type stereoscopic video in which right-eye image frames and left-eye image frames are to be displayed on the screen alternately and sequentially, the following problem arises.

In general, to cause a viewer to recognize a particular object in an image three-dimensionally, stereoscopic video is displayed in such a manner that the positions, on the screen, of the object in a right-eye image and a left-eye image are deviated from each other (a parallax is produced). Furthermore, for such stereoscopic video, the right-eye shutter and the left-eye shutter of glasses with shutters are provided so as to be opened and closed individually. A control is made so as to open the right-eye shutter and close the left-eye shutter when a right-eye image is displayed, and vice versa. This type of method in which a viewer is caused to recognize video on the screen three-dimensionally by performing a sync control on the video and the glasses with shutters is employed in many cases.

If the technique described in JP-A-2006-157775 is applied to time-division-type stereoscopic video, a left-eye image frame is used for compensation of a right-eye image and vice versa.

However, since, as described above, the positions, on the screen, of an object in a right-eye image and a left-eye image are deviated from each other to produce a parallax, it is highly probable that a latest image frame is compensated based on erroneous information if it is compensated by using the video information of the immediately preceding image frame.

### BRIEF DESCRIPTION OF THE DRAWINGS

A general configuration that implements the various features of the present invention will be described with reference to the drawings. The drawings and the associated descriptions are provided to illustrate embodiments of the invention and not to limit the scope of the invention.

FIG. 1 is a block diagram showing a configuration of a TV receiver (image quality adjusting apparatus) according to an embodiment of the present invention.

FIG. 2 shows a system configuration consisting of blocks for performing plural respective pieces of processing on an input video signal in the embodiment.

FIG. 3 shows a system configuration consisting of blocks for performing image quality adjustment processing on each frame-rate-converted frame image based on a corresponding pre-frame-rate-conversion frame image in the embodiment.

FIG. 4 is a conceptual diagram showing a relationship between input left-eye/right-eye frame images and output left-eye and right-eye frame images of an L/R frame separator and a relationship between input left-eye and right-eye frame images and output left-eye and right-eye frame images of a frame rate converter.

FIG. 5 is a conceptual diagram for description of the necessity for adjusting the image quality of each frame-rate-converted left-eye or right-eye frame image based on a corresponding pre-frame-rate-conversion left-eye or right-eye frame image.

FIG. 6 shows a modified system configuration consisting of blocks for performing image quality adjustment processing on each frame-rate-converted frame image based on a corresponding pre-frame-rate-conversion frame image.

### DETAILED DESCRIPTION

According to the embodiments described herein, there is provided an image quality adjusting apparatus including: an output module configured to alternately output, in time division, first and second frame-rate-converted frame images that are obtained by converting first and second input frame images to increase a frame rate, respectively; a detecting module configured to detect features of each of the first and second input frame images; and an image quality adjusting module configured to perform an image quality adjustment on the first frame-rate-converted frame image based on the detected features of the first input frame image and performing an image quality adjustment on the second frame-rate-converted frame image based on the detected features of the second input frame image.

Embodiments according to the present invention will be described in detail with reference to the accompanying drawings. The scope of the claimed invention should not be limited to the examples illustrated in the drawings and those described in below.

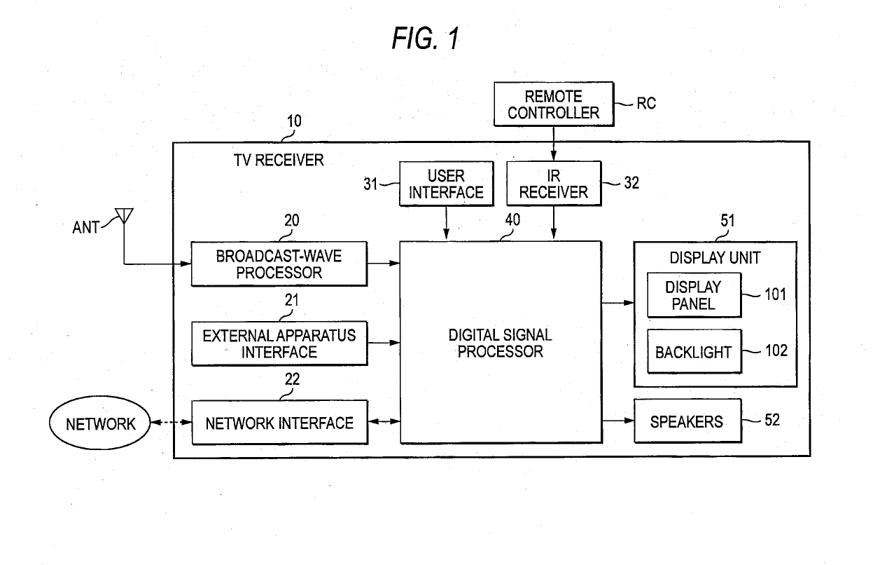

FIG. 1 is a block diagram showing a configuration of a TV receiver 10 (image quality adjusting apparatus) according to the embodiment of the invention.

The TV receiver 10 according to the embodiment includes a broadcast-wave processor 20, an external apparatus interface 21, a network interface 22, a user interface 31, an IR receiver 32, a digital signal processor 40, a display unit 51, speakers 52, etc. An antenna ANT is connected to the broadcast-wave processor 20. The IR receiver 32 exchanges information with a remote controller RC. The display unit 51 includes a display panel 101, a backlight 102, etc.

The TV receiver 10 performs various processing on stereoscopic video (three-dimensional video) having prescribed format that is input from the broadcast-wave processor 20, the external apparatus interface 21, or the network interface 22, and displays resulting stereoscopic video on the display unit 51. The stereoscopic video that is displayed on the display unit 51 is of the time-division type, that is, left-eye frame images (hereinafter referred to as L frames) and right-eye frame images (hereinafter referred to as R frames) are displayed alternately and sequentially on the screen. The stereoscopic video having the prescribed format which is input from the section 20, 21, or 22 is in a form that a left-eye frame component and a right-eye frame component exist in mixture in each frame image or a time-division form that L frames and R frames are arranged alternately and sequentially. The TV receiver 10 displays, on the display unit 51, frame-rate-increased stereoscopic video obtained by converting the input stereoscopic video.

The broadcast-wave processor 20 is equipped with tuners and decoders for processing ground-wave digital broadcast waves, satellite digital broadcast waves, and analog broadcast waves received by the antenna ANT. The broadcast-wave processor 20 acquires signals received by the antenna ANT, tunes in to a signal on a particular channel among the acquired signals, demodulates and decodes the thus-selected signal, and outputs a signal that contains program audio-video information, program-related information, etc. to the digital signal processor 40. The program-related information is such information as a program channel number, a broadcast wave type, a broadcasting station name, a program name, and a genre. The broadcast-wave processor 20 acquires and outputs a stereoscopic video signal.

The external apparatus interface 21 is equipped with connection terminals that comply with various standards such as the HDMI (registered trademark) standard, the USB standard and the IEEE 1394 standard and an information extracting section for extracting particular information according to any of these standards. The external apparatus interface 21 acquires a signal containing audio-video information of a content, program-related information, etc. from an information providing source connected to a connection terminal such as an external apparatus or a storage medium such as an external HDD or a memory card, and outputs the acquired signal to the digital signal processor 40. In the embodiment, the external apparatus interface 21 acquires and outputs a stereoscopic video signal.

The network interface 22 is equipped with a connection terminal for connection to a network such as the Internet, a LAN, or a WAN and a communication section for performing communication over the network via the connection terminal. The network interface 22 acquires a signal containing audio-video information of a content, program-related information, etc. from an information providing source such as a particular server located on the other side of a connected network, and outputs the acquired signal to the digital signal processor 40. Furthermore, the network interface 22 acquires a signal containing audio-video information of a content, program-related information, etc. from a storage medium connected via a network such as an external HDD (located outside the TV receiver 10) or a memory card, and outputs the acquired signal to the digital signal processor 40. The network interface 22 acquires and outputs a stereoscopic video signal.

The user interface 31 has keys for receiving a command input for operating the TV receiver 10. The user interface 31 receives information of a command input and outputs it to the digital signal processor 40. Likewise, the IR receiver 32 receives light that carries information of a command input from the remote controller RC and outputs that information to the digital signal processor 40. Each of the user interface 31 and the remote controller RC has a selection key for making a section as to which of the broadcast-wave processor 20, the external apparatus interface 21, and the network interface 22 a signal should be acquired from, and other keys.

The digital signal processor 40 performs, according to information of a command input supplied from the user interface 31 or the IR receiver 32, various kinds of processing such as processing of expanding compressed data and processing of extracting information to be used for generating a program table on a signal that is input from the broadcast-wave processor 20, the external apparatus interface 21, the network interface 22, or the like. The digital signal processor 40 performs, on an input signal, various kinds of processing such as processing of separating a video signal and an audio signal from each other, MPEG decoding computation, and video image quality adjustment processing, and outputs a resulting video signal and audio signal to the display unit 51 and the speakers 52, respectively. Furthermore, equipped with a CPU or a microcomputer (not shown) as a controller, the digital signal processor 40 controls plural pieces of processing using modules provided in itself or connected to it.

In the embodiment, if the input video signal is of stereoscopic video (original frame images) in which an L frame component and an R frame component exist in mixture in each frame image, the digital signal processor 40 performs L/R frame separation processing of separating an L frame and an R frame from each other and arranging L frames and R frames alternately in time division. The digital signal processor 40 performs frame rate conversion processing, that is, performs frame rate conversion on input stereoscopic video and outputs resulting stereoscopic video. Furthermore, the digital signal processor 40 performs image quality adjustment processing of adjusting the image quality of each of a frame-rate-converted L frame and R frame.

The display unit 51 is a display module for displaying a video signal that is output from the digital signal processor 40. For example, the display unit 51 can be a flat display such as an LCD (liquid crystal display) or a PDP (plasma display panel). In the display unit 51, a video signal that is input from the digital signal processor 40 is displayed on the display panel 101 which is a light-transmission-type panel and the backlight 102 is turned on/off according to a control signal that is supplied from the processing controller 40. The backlight 102 is of such a type that area control (also called local dimming) is possible, that is, the illuminance values of plural respective areas are individually adjustable. Although the following description will be directed to a case that the display unit 51 is an LCD, the invention is not limited to such a case.

The speakers 52 output audio signals that are input from the digital signal processor 40.

Instead of performing plural pieces of processing on an input signal that is input from the broadcast-wave processor 20, the external apparatus interface 21, the network interface 22, or the like, the digital signal processor 40 may perform plural pieces of processing on an input signal that is input from a storage medium (not shown) such as an HDD that is provided inside the TV receiver 10 and stored with signal data.

The embodiment is directed to the TV receiver 10 which is an example image quality adjusting apparatus to which the invention is applied. Alternatively, the invention may be applied to other image quality adjusting apparatus such as an HDD recorder, a DVD recorder, a personal computer, a mobile/portable terminal, and a set-top box which have the same essential features as the TV receiver 10 according to the embodiment. That is, the invention is not limited in such items as the broadcast-wave type and the signal acquisition path, and can be applied to any image quality adjusting apparatus having a constituent element for merely processing a video signal.

Having the above-described configuration, in the TV receiver 10 according to the embodiment of the invention, if stereoscopic video in which an L frame component and an R frame component exist in mixture in each frame image is input, they are separated from each other. The TV receiver 10 performs frame rate conversion processing on L and R frames of input stereoscopic video having a prescribed format and outputs resulting stereoscopic video. Furthermore, the TV receiver 10 performs, on each frame-rate-converted L frame or R frame, image quality adjustment processing for image quality improvement by referring to an appropriate image frame.

The above pieces of processing are mainly performed by the digital signal processor 40 on an input signal that is input from the broadcast-wave processor 20 or the like.

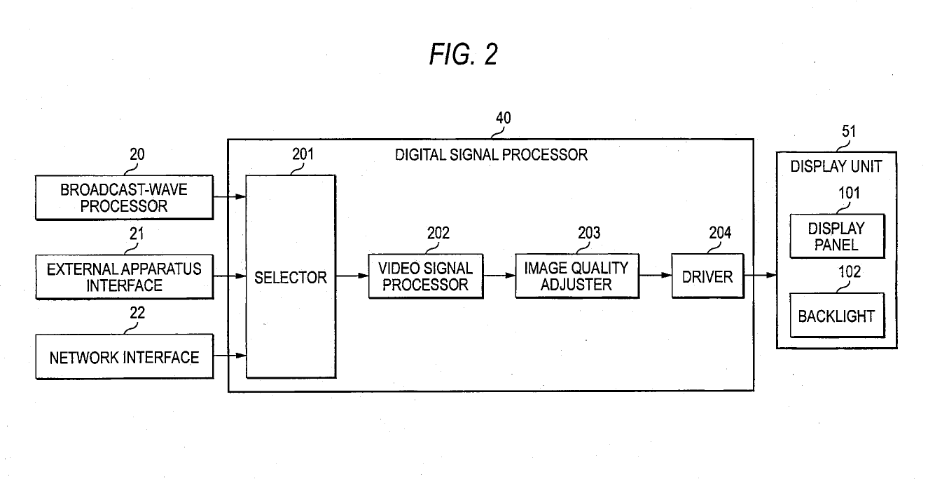

Next, blocks that are provided in the digital signal processor 40 described above with reference to FIG. 1 and perform plural respective pieces of processing on an input video signal will be described with reference to FIG. 2.

FIG. 2 shows a system configuration consisting of blocks for performing plural respective pieces of processing on an input video signal in the embodiment.

The digital signal processor 40 according to the embodiment is provided with a selector 201, a video signal processor 202, an image quality adjusting module 203, a driver 204, etc. The digital signal processor 40 is provided with plural blocks for performing various kinds of processing on an audio signal in addition to the above blocks for processing a video signal. However, the following description will be directed to the plural blocks for performing various kinds of processing on a video signal and the blocks for processing an audio signal will not be described.

The selector 201 outputs, to the video signal processor 202, video information that is supplied from the broadcast-wave processor 20, the external apparatus interface 21, or the network interface 22 that is selected by the user of the TV receiver 10 using the selection key (not shown) which is provided in the user interface 31 or the remote controller RC. The selector 201 may be provided outside the digital signal processor 40 rather than inside the digital signal processor 40.

The video signal processor 202 performs MPEG decoding computation etc. on the video signal that is input from the selector 201 and outputs, to the image quality adjusting module 203, a frame image signal which is a frame-by-frame video signal for display on the display unit 51. Where the input video signal is of stereoscopic video, the video signal processor 202 outputs a signal of frame images (original frame images) in each of which an L frame component and an R frame component exist in mixture or a signal of L and R frames that are arranged alternately and sequentially.

The image quality adjusting module 203 performs frame rate conversion processing of converting the frame images that are input from the video signal processor 202 so that the frame rate is increased. The image quality adjusting module 203 performs image quality adjustment processing on each frame-rate-converted frame image based on features of a pre-frame-rate-conversion frame image, and outputs a signal of the frame-rate-converted frame images to the driver 204. In particular, where the input frame images are of stereoscopic video in which an L frame component and an R frame component exist in mixture in each frame image, the image quality adjusting module 203 separates each input frame image into an L frame and an R frame and performs frame rate conversion processing on each of the separated L and R frames. The image quality adjusting module 203 performs image quality adjustment processing on each frame-rate converted L or R frame based on features of a separated, pre-frame-rate-conversion frame image.

That is, this image quality adjustment processing is performed on each frame-rate-converted frame image based on features of a pre-frame-rate-conversion frame image. In particular, where the input frame images are of stereoscopic video, the image quality adjustment processing is performed on each frame-rate-converted L frame based on features of a pre-frame-rate-conversion L frame and on each frame-rate-converted R frame based on features of pre-frame-rate-conversion R frame.

The driver 204 controls the frame image signal that is input from the image quality adjusting module 203 to make it displayable by the display unit 51, and outputs a resulting frame image signal to the display panel 101 of the display unit 51. The driver 204 also controls the backlight 102 so as to turn on/off its particular areas in synchronism with the frame image signal that is input from the image quality adjusting module 203.

With the above system configuration, part of the digital signal processor 40 according to the embodiment of the invention performs image quality adjustment processing on each frame-rate-converted frame image based on features of a corresponding pre-frame-rate-conversion frame image. In this manner, image quality adjustment processing for image quality improvement is performed by referring to an appropriate image frame.

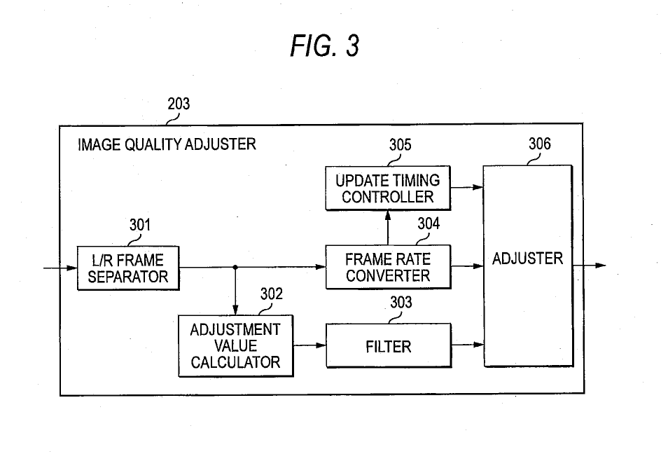

Next, operations of the respective blocks that are provided in the image quality adjusting module 203 described above with reference to FIG. 2 and perform image quality adjustment processing on each frame-rate-converted frame image based on a corresponding pre-frame-rate-conversion frame image will be described with reference to FIG. 3.

FIG. 3 shows a system configuration consisting of blocks for performing image quality adjustment processing on each frame-rate-converted frame image based on a corresponding pre-frame-rate-conversion frame image in the embodiment.

The image quality adjusting module 203 is provided with an L/R frame separator 301, an adjustment value calculator 302, a filter 303, a frame rate converter 304, an update timing controller 305, an adjuster 306, etc.

If an L frame component and an R frame component exist in mixture in each frame image that is input from the upstream block, the L/R frame separator 301 performs L/R frame separation processing of separating the L frame and the R frame from each other and produce L frames and R frames that are arranged alternately in time division. The resulting L frames and R frames are output to the frame rate converter 304. For example, where an L frame component and an R frame component are mixed by a side-by-side method, they are separated from each other by performing expansion processing in the horizontal direction. Where an L frame component and an R frame component are mixed by a line-by-line method, they are separated from each other by performing expansion processing in the vertical direction. In this case, the frame rate of the output L and R frames is two times that of the input frame images. For example, image frames of 60 (fps) are converted into output L and R frames of 120 (fps). This is because the output L and R frames are arranged in time division. If each frame image that is input from the upstream block is such that L frame portions and R frame portions are arranged alternately as in the case of a frame packing method, the set of L frame portions and the set of R frame portions are separated from each other into independent image frames, which are output as two image frames. Therefore, also in this case, the frame rate of the output frame images is two times that of the input frame images.

The adjustment value calculator 302 detects pieces of lightness information (information relating to luminance or brightness) of particular pixels as features of each of an L frame and an R frame that are input from the L/R frame separator 301, calculates an adjustment value based on the detected pieces of lightness information, and outputs the calculated adjustment value to the filter 303. The adjustment value calculator 302 detects pieces of lightness information and calculates an adjustment value for each divisional region of each of an L frame and an R frame. The adjustment value may be an average or a maximum value of pieces of lightness information of all pixels or arbitrary pixels of each region. The adjustment value calculator 302 may detect color information, rather than lightness information, of particular pixels. A modification is possible in which an adjustment value is calculated for one of an input L frame and R frame that are input from the L/R frame separator 301 instead of both of them. It is preferable that two adjustment value calculators 302 be provided to process L frames and R frames, respectively.

The filter 303 converts the adjustment value that is input from the adjustment value calculator 302 into an effective adjustment value according to a prescribed transfer characteristic, and outputs the effective adjustment value to the adjuster 306. Example transfer characteristics are filtering by a first-order LPF, filtering by a second-order LPF, and simple delay (i.e., output of one-sample-preceding values). The filter 303 is a digital filter which receives a digital adjustment value and outputs a digital effective adjustment value. The filter 303 outputs an effective adjustment value for each of an L frame and an R frame that are input from the adjustment value calculator 302 based on an adjustment value for each of the L frame and the R frame. It is preferable that two filters 303 be provided to process L frames and R frames, respectively.

The frame rate converter 304 converts an L frame and an R frame that are input from the L/R frame separator 301 into a frame-rate-increased L frame and R frame (frame-rate-converted L frame and R frame), and outputs the latter to the adjuster 306. The frame rate converter 304 increases the frame rate by adding a new frame image by copying an input L frame or R frame. The frame rate converter 304 may increase the frame rate by adding a new frame image by interpolating it based on immediately preceding and following L or R frames. That is, no limitations are imposed on the method for converting input frame images so as to increase the frame rate and various methods can be employed for this purpose. The frame rate converter 304 outputs L frames and R frames in an alternate form (e.g., LRLR) or a form in which same frame images are output successively (e.g., LLRR). For example, if the frame rate converter 304 converts input L frames and R frames having a frame rate 120 (fps) into L frames and R frames in which two same frame images are arranged successively (LLRR), the L frames and R frames are output at a frame rate 240 (fps).

The update timing controller 305 outputs, to the adjuster 306, output delay information indicating to what extent (with what update timing) a frame-rate-converted L or R frame (output L or R frame) is delayed based on an L or R frame that is input to the frame rate converter 304. That is, it can be said that the output delay information is information to be used for synchronizing frame images that are input to the frame rate converter 304 with frame images that are output from the frame rate converter 304.

The adjuster 306 applies an adjustment result that is based on the effective adjustment value that is input from the filter 303 to an L or R frame having prescribed timing according to the output delay information that is input from the update timing controller 305. The adjustment result may be one of signal information (parameter) to be used for adjusting the luminance or brightness for the signal level of video to be displayed on the display panel 101 and light quantity information to be used for adjusting the luminance or brightness (illuminance of illumination) for the emission light quantity of the backlight 102. More specifically, the adjuster 306 determines light quantity information for the backlight 102 based on the input effective adjustment value and outputs, to the driver 204, in synchronism with an input L or R frame, the light quantity information which is to be used for adjusting the emission light quantity of the backlight 102. The adjuster 306 further determines signal information for the signal level of video to be displayed on the display panel 101 based on the determined light quantity information, and adjusts the input L or R frame by merely using the signal information or by performing a signal-information-based adjustment and a light-quantity-based adjustment with appropriate weights. Where the adjustment subject L frames and R frames are such that same frame images are arranged successively and are to be adjusted through the illuminance of the illumination by the backlight 102, the illuminance of the illumination for each frame image may be varied according to the number of same, successive frame images. More specifically, where an illuminance value 100 is to be attained (adjustment) by illuminating operations for two same frame images, illumination values for the first and second frame images may be set as appropriate so as to attain the total illumination value 100; for example, illumination values for the first and second frame images are set at 70 and 30, respectively.

Each of the blocks of the image adjuster 203 is implemented by hardware or through cooperation between hardware and software.

Through operations of the above respective blocks, the image quality adjusting module 203 can adjust the image quality of each frame-rate-converted frame image based on a corresponding pre-frame-rate-conversion frame image. The processing for image quality improvement can thus be performed by referring to an appropriate image frame.

Next, a relationship between input left-eye/right-eye frame images and output left-eye and right-eye frame images of the L/R frame separator 301 and a relationship between input left-eye and right-eye frame images and output left-eye and right-eye frame images of the frame rate converter 304 will be described.

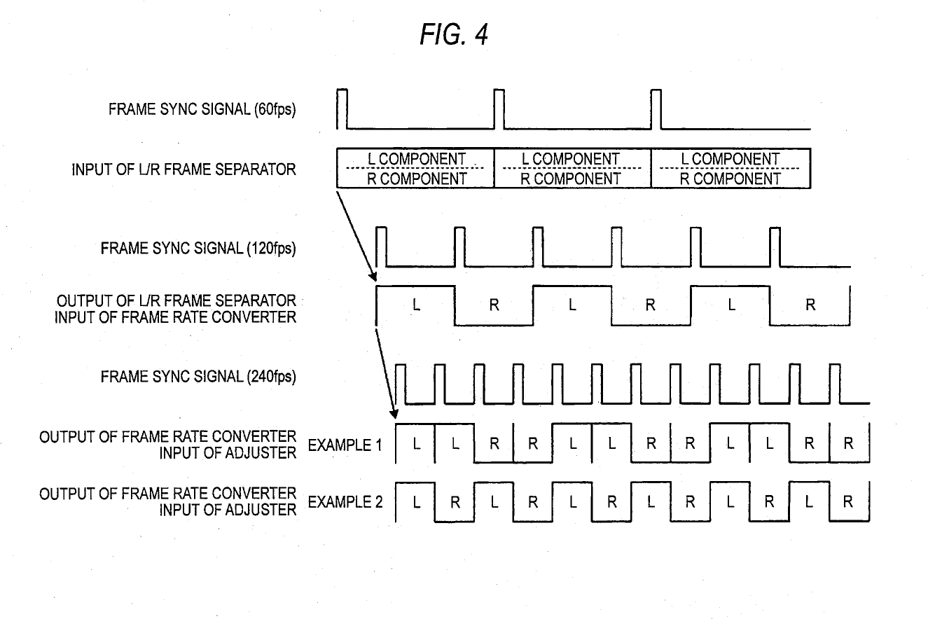

FIG. 4 is a conceptual diagram showing a relationship between input left-eye/right-eye frame images and output left-eye and right-eye frame images of the L/R frame separator 301 and a relationship between input left-eye and right-eye frame images and output left-eye and right-eye frame images of the frame rate converter 304.

FIG. 4 corresponds to a case that L/R frames that are input to the L/R frame separator 301 are of stereoscopic video in which an L frame component and an R frame component exist in mixture in each frame image and have a frame rate 60 (fps).

That is, at the input of the L/R frame separator 301, L/R frames having a frame rate 60 (fps) are such that an L frame component and an R frame component exist in mixture in each frame image.

The L/R frame separator 301 performs L/R frame separation processing, whereby an L frame and an R frame of each L/R frame are separated from each other and arranged in time division. At this time, each of the L frame and the R frame is separated and output as one frame. Therefore, at the output of the L/R frame separator 301 (input of the frame rate converter 304), the frame sync signal has a frame rate 120 (fps) which is two times the above-mentioned rate 60 (fps). Each separated set of an L frame and an R frame at the output of the L/R frame separator 301 is delayed from a corresponding L/R frame at the input of the L/R frame separator 301 as a result of the execution of the L/R frame separation processing.

Subsequently, the frame rate converter 304 rearranges the L and R frames having the frame rate 120 (fps) into L and R frames in which same frame images occur successively as exemplified by “LLRR” (example 1) or they appear alternately as exemplified by “LRLR” (example 2). At this time, each of newly added L and R frames is output as one frame. Therefore, at the output of the frame rate converter 304 (input of the adjuster 306), the frame sync signal has a frame rate 240 (fps) which is two times the above-mentioned rate 120 (fps). Each set of converted L frames or R frames at the output of the frame rate converter 304 is delayed from a corresponding L frame or R frame at the input of the frame rate converter 304 as a result of the execution of the frame rate conversion processing.

Although as described above delay occurs between the input and the output of the L/R frame separator 301 and between the input and the output of the frame rate converter 304, it is possible to manage the relationship between corresponding input and output frame images of each of the L/R frame separator 301 and the frame rate converter 304. That is, the image quality of each frame-rate-converted frame image can be adjusted based on a corresponding pre-frame-rate-conversion frame image. Processing for image quality improvement can thus be performed by referring to an appropriate image frame.

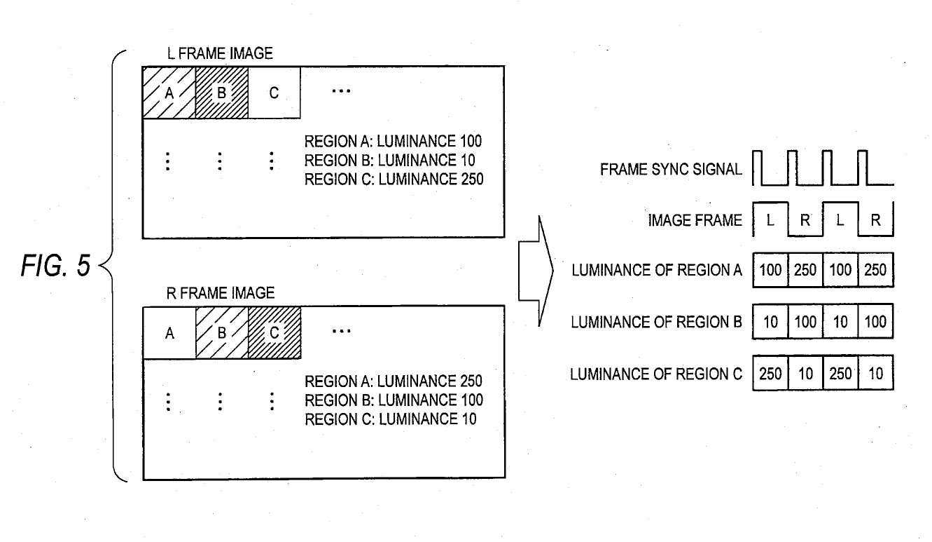

Next, the necessity for adjusting the image quality of each frame-rate-converted left-eye or right-eye frame image based on a corresponding pre-frame-rate-conversion left-eye or right-eye frame image will be described with reference to FIG. 5.

FIG. 5 is a conceptual diagram for description of the necessity for adjusting the image quality of each frame-rate-converted left-eye or right-eye frame image based on a corresponding pre-frame-rate-conversion left-eye or right-eye frame image.

As shown in FIG. 5, each of an L frame and an R frame is divided into plural regions A, B, C, . . . . A description will be made of a case that at a certain time point pieces of lightness information of regions A, B, and C of the L frame are 100, 10, and 250 in luminance, respectively, and pieces of lightness information of regions A, B, and C of the R frame are 250, 100, and 10 in luminance, respectively. This results from the fact that screen display positions, for an L frame and an R frame of stereoscopic video, of an object are deviated from each other to produce such a parallax that the object is recognized three-dimensionally.

Referring to FIG. 5, a video portion that is displayed in region A of the L frame corresponds to a video portion that is displayed in region B of the R frame. A video portion that is displayed in region B of the L frame corresponds to a video portion that is displayed in region C of the R frame. Display positions of the same object are thus deviated from each other. Therefore, where the L and R frames having the above-mentioned piece of lightness information are arranged in time division, the same regions of the L frame and the R frame may have different luminance values. For example, region A has the luminance values 100 and 250 in the L frame and the R frame, respectively. Region B has the luminance values 10 and 100 in the L frame and the R frame, respectively.

Therefore, if an image quality adjustment is performed on a latest L frame image based on features of the immediately preceding R frame or on a latest R frame image based on features of the immediately preceding L frame, the image quality adjustment becomes erroneous because of luminance differences between the latest frame and the immediately preceding frame. More specifically, in the case of region A, for example, the luminance value 250 which is a feature of the R frame is adjusted using an adjustment value that partially reflects the luminance value 100 of the L frame.

As shown in FIG. 4, the frame rate of L and R frames at the output of the frame rate converter 304 is 240 (fps). The blocks which perform plural pieces of processing on frame images having such a high frame rate are required to have a high computation ability, which raises cost-related or technical problems to be solved in constructing the system. These problems can be solved easily by performing the processing of detecting features of a pre-frame-rate-conversion frame image having a frame rate 60 or 120 (fps) and the processing of calculating an adjustment value based on the detected features.

This is the reason why it is necessary to adjust the image quality of each frame-rate-converted frame image based on a corresponding pre-frame-rate-conversion L or R frame image. Processing for image quality improvement needs to be performed by referring to an appropriate image frame, and the TV receiver 10 according to the embodiment can attain this object.

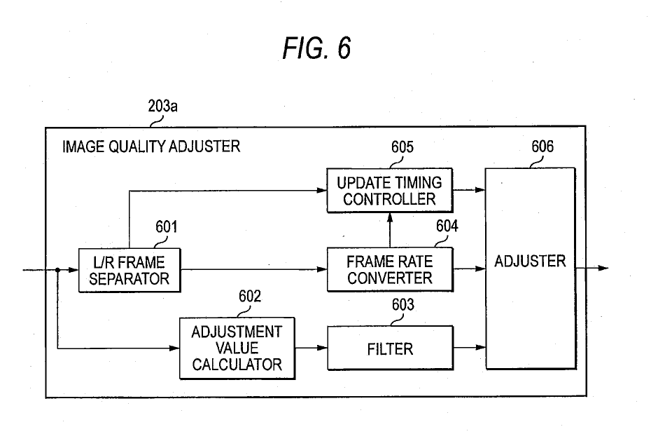

Next, modified operations of the respective blocks that are provided in the image adjuster 203 described above with reference to FIG. 2 and perform image quality adjustment processing on each frame-rate-converted left-eye or right-eye frame image based on a corresponding pre-frame-rate-conversion frame image will be described with reference to FIG. 6.

FIG. 6 shows a modified system configuration consisting of blocks for performing image quality adjustment processing on each frame-rate-converted frame image based on a corresponding pre-frame-rate-conversion frame image.

An image quality adjusting module 203a is provided with an L/R frame separator 601, an adjustment value calculator 602, a filter 603, a frame rate converter 604, an update timing controller 605, an adjuster 606, etc.

The modified system configuration of FIG. 6 is approximately the same as that of FIG. 3 except in parts of the operations of the adjustment value calculator 602 and the update timing controller 605. The operations of the L/R frame separator 601, filter 603, frame rate converter 604, and adjuster 606 are the same as the operations of the L/R frame separator 301, filter 303, frame rate converter 304, and adjuster 606, and hence will not be described in detail.

If an L frame component and an R frame component exist in mixture in each frame image that is input from the upstream block, the L/R frame separator 601 separates the L frame and the R frame from each other by time division into independent frame images and outputs resulting L frames and R frames to the frame rate converter 604.

The adjustment value calculator 602 detects pieces of lightness information (information relating to luminance or brightness) of particular pixels as features of each of an pre-frame-separation L and R frames that are input from the upstream block to the L/R frame separator 601, calculates an adjustment value based on the detected pieces of lightness information, and outputs the calculated adjustment value to the filter 603. The adjustment value calculator 602 detects pieces of lightness information and calculates an adjustment value for each divisional region of each of the L frame and the R frame. A modification is possible in which an adjustment value is calculated for one of an input L frame and R frame that are input from the upstream block instead of both of them. It is preferable that two adjustment value calculators 602 be provided to process L frames and R frames, respectively.

The filter 603 converts the adjustment value that is input from the adjustment value calculator 602 into an effective adjustment value according to a prescribed transfer characteristic, and output the effective adjustment value to the adjuster 606. The filter 603 outputs an effective adjustment value for each of an L frame and an R frame that are input from the adjustment value calculator 602 based on an adjustment value for each of the L frame and the R frame. It is preferable that two filters 603 be provided to process L frames and R frames, respectively.

The frame rate converter 604 converts an L frame and an R frame that are input from the L/R frame separator 601 into a frame-rate-increased L frame and R frame, and outputs the latter to the adjuster 606.

The update timing controller 605 outputs, to the adjuster 606, output delay information indicating to what extent (with what update timing) a frame-rate-converted L or R frame (output L or R frame) is delayed based on an L or R frame that is input to the L/R frame separator 601.

The adjuster 606 adjusts an L or R frame having prescribed timing that is input from the frame rate converter 604 by applying the effective adjustment value that is input from the filter 603 to the L or R frame according to the output delay information that is input from the update timing controller 605, and outputs an adjustment result to the downstream block.

Through operations of the above respective blocks, the image quality adjusting module 203a can adjust the image quality each frame-rate-converted frame image based on a corresponding pre-frame-separation, pre-frame-rate-conversion frame image. The processing for image quality improvement can thus be performed by referring to an appropriate image frame.

According to the embodiment, part of the blocks of the digital signal processor 40 of the TV receiver 10 can mainly adjust the image quality of each frame-rate-converted frame image based on a corresponding pre-frame-separation frame image (at least a corresponding pre-frame-rate-conversion frame image). The processing for image quality improvement can thus performed by referring to an appropriate image frame.

Although the embodiments according to the present invention have been described above, the present invention is not limited to the above-mentioned embodiments but can be variously modified. Constituent components disclosed in the aforementioned embodiments may be combined suitably to form various modifications. For example, some of all constituent components disclosed in the embodiments may be removed or may be appropriately combined.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image quality adjusting apparatus comprising:
an output module configured to alternately output, in time division, first and second frame-rate-converted frame images that are obtained by converting first and second input frame images to increase a frame rate, respectively;
a detecting module configured to detect features of each of the first and second input frame images; and
an image quality adjusting module configured to perform an image quality adjustment on the first frame-rate-converted frame image based on the detected features of the first input frame image and performing an image quality adjustment on the second frame-rate-converted frame image based on the detected features of the second input frame image.

2. The apparatus of claim 1,
wherein the detecting module is configured to detect features relating to luminance or brightness of each of the first and second input frame images, and
wherein the image quality adjusting module is configured to perform an image quality adjustment relating to luminance or brightness on each of the first and second frame-rate-converted frame images based on the detected features of each of the first and second input frame images.

3. The apparatus of claim 2,
wherein the image quality adjusting module is configured to perform an image quality adjustment relating to luminance or brightness on each of the first and second frame-rate-converted frame images by adjusting a parameter, relating to luminance or brightness, of a video signal or illuminance of illumination for a panel for displaying a video signal.

4. The apparatus of claim 1,
wherein the image quality adjusting module is configured to perform an image quality adjustment on each of the first and second frame-rate-converted frame images based on the detected features of one of the first and second input frame images.

5. The apparatus of claim 1,
wherein the image quality adjusting module is configured to perform an image quality adjustment on each of the first and second frame-rate-converted frame images based on an average feature of the detected features of each of the first and second input frame images.

6. The apparatus of claim 1,
wherein the detecting module is configured to detect features for each of divisional regions of each of the first and second input frame images, and
wherein the image quality adjusting module is configured to perform an image quality adjustment on each of regions corresponding to the respective divisional regions of each of the first and second frame-rate-converted frame images.

7. The apparatus of claim 1 further comprising:
a separator configured to separate an original frame image in which signals of the first and second input frame images exist in mixture into first and second frame images features,
wherein the detecting module is configured to detect features from each of the signals of the first and second input frame images that have not been separated by the separator yet.

8. The apparatus of claim 1,
wherein the image quality adjusting module is configured to perform an image quality adjustment in which an adjustment value for each frame image is varied depending on the number of successive first or second frame-rate-converted frame images.

9. The apparatus of claim 1,
wherein the first input frame image is a left-eye frame image of stereoscopic video and the second input frame image is a right-eye frame image of the stereoscopic video.

10. An image quality adjusting method comprising:
alternately outputting, in time division, first and second frame-rate-converted frame images obtained by converting first and second input frame images to increase a frame rate, respectively;
detecting features of each of the first and second input frame images; and
performing an image quality adjustment on the first frame-rate-converted frame image based on the detected features of the first input frame image and performing an image quality adjustment on the second frame-rate-converted frame image based on the detected features of the second input frame image.
